(19) United States
(12) Patent Application Publication
(10) Pub. No.: US 2015/0061244 A1
(43) Pub. Date: Mar. 5, 2015

(54) METHOD FOR TUNING THE SUSPENSION OF A MOTOR VEHICLE, AND SUSPENSION STRUT

(71) Applicant: RHEINISCH-WESTFÄLISCHE TECHNISCHE HOCHSCHULE AACHEN, Aachen (DE)

(72) Inventors: Michael Klein, Muenchen (DE); Uwe Kessels, Eschweiler (DE); Lutz Eckstein, Aachen (DE)

(21) Appl. No.: 14/389,966

(22) PCT Filed: Apr. 16, 2013
(86) PCT No.: PCT/EP2013/001119

§ 371 Date: Oct. 1, 2014

(30) Foreign Application Priority Data
Apr. 17, 2012 (DE) 102012007519.7

(51) Int. Cl. G01M 17/04; B60G 15/06; B60G 17/015

(52) U.S. Cl. CPC G01M 17/04; B60G 17/0157; B60G 15/062
USPC 280/5.515

(57) ABSTRACT

The invention relates to a method for tuning the suspension of a motor vehicle. A linear motor (7, LM), in particular a linear electric motor (7, LM), is arranged in the suspension strut of each vibration damper (k₂), in particular controllable vibration damper (k₂), of at least one axle of the two axles of the chassis in a parallel manner relative to said vibration damper (k₂). The linear motor (7, LM) is connected to the sprung mass (m₂) of the motor vehicle on one side of the linear direction of action of the motor and to the unsprung mass (m₁) of the motor vehicle on the other side via the same fixing points as the corresponding vibration damper (k₂). Each linear motor (7, LM) is controlled by means of a controller dependent on measured values which are detected while the vehicle is traveling, and additional forces are added to and/or subtracted from the forces acting on the respective vibration damper (k₂). The invention further relates to a suspension strut (1) for a chassis of a motor vehicle, comprising an upper hinge point (2) for connecting the suspension strut (1) to the sprung mass (m₂) of the motor vehicle, a lower hinge point (3) for connecting the suspension strut (1) to the unsprung mass (m₁) of the motor vehicle, and a pairing of a vibration damper (k₂, 4) and a suspension spring (c₂, 5), said pairing being arranged between the hinge points (2, 3), wherein a linear motor (7, LM) is arranged parallel to said pairing and extends between the same hinge points (2, 3).

The invention relates to a method of tuning the suspension of a motor vehicle. The invention furthermore relates to a strut of a motor-vehicle suspension comprising a top pivot connecting a shock absorber to the sprung mass of the motor vehicle, in particular, by elastomer bearings, and a bottom pivot connecting the shock absorber to the unsprung mass of the motor vehicle, in particular, by elastomer bearings, and comprising an assembly composed of a vibration damper and a spring that are provided between the pivots.

Shock absorbers of this type as well as methods for suspension tuning as are well known in the prior art. For example, vibration dampers can be used on a shock absorber, the dampers being adjustable and/or controllable, which approach essentially means that the fluid flow cross-section through the piston of the vibration damper, the spring stiffness of the valve plate arrangement, or the viscosity of the fluid can be modified as a function of external variables.

During the definition phase, proof-of-concept phase, or production development phase of motor vehicles, for example, the approach is well-known in the prior art of modifying the previous production suspension of the preceding production vehicle in order to thereby obtain the initial characteristics for a vehicle tuning to be developed for a new motor vehicle to be put on the market.

In addition to computer-based simulation modifications of the suspension during modeling and model analysis, in particular, for the shock absorber of the respective suspension, test runs and tuning runs are performed by experienced test and trial drivers for purposes of system integration in order to then be able to modify the response of the spring characteristic and/or of the vibration damper characteristic of a given shock absorber so as to meet the vehicle performance characteristics as required by the specifications. This characteristic plots the forces acting on or through the given element against the displacement or the speed of the relevant element in the element's axial direction of operation, thus in the case of a spring, for example the force of the spring against the stroke or travel of the two ends of the spring relative to each other, and in the case of a vibration damper the load against the stroke or travel or against the speed of the piston rod relative to the cylinder.

What is considered problematic here is that although shock absorbers known in the prior art can optionally employ vibration dampers controlled with or without feedback, these vibration dampers nevertheless do not allow any desired changes of the respective characteristics to be effected; on the contrary, redesign of the vibration damper dimensions and valve characteristics, additional bypass holes, adjusting the flow cross-sections in the piston of this type of vibration damper, or modifying the fluid properties, for example, enable only one characteristic out of a family of multiple characteristics to be selected. Analogous limitations apply for coil springs in which, for example, the spring length in the rest position, coil diameter and pitch, and distance between coils can be modified.

If, on the other hand, the intention is to effect changes in one characteristic, for example of a spring or vibration damper, which changes extended beyond the possibilities provided by a family of multiple characteristics, the approach of the prior art previously has been in the case of vibration dampers to change the characteristic by substituting prototypes having the above-mentioned means of manipulating the properties, and in the case of springs to swap out the entire spring. This requires removing the given element to be changed from the suspension, which approach is obviously laborious in terms of time and cost.

The object of the invention is therefore to provide a method of tuning a suspension, and a shock absorber that is suitable for this purpose and that easily enables essentially any desired suspension tuning to be achieved, in particular, a modified tuning relative to a previous vehicle production run, without in terms of construction having to modify for this purpose the vibration dampers used in a suspension between different test runs. A further object of the invention is to provide a method of tuning a suspension that can enable a suspension tuning to be implemented in a production vehicle and that can also enable it to be used only in a preproduction vehicle in order to find a new suspension tuning of a suspension relative to a preproduction model when defining the catalog of requirements.

Another object of the invention is to create the ability to retrofit existing suspensions in order thereby to acquire information for a desired re-tuning of the suspension.

This object is achieved according to the invention by a method of tuning the suspension of a motor vehicle in which a linear actuator is provided in each of the shock absorbers associated with and parallel to the respective vibration damper, in particular, to each controllable vibration damper of at least one axle of the two axles of the suspension chassis, the linear actuator being connected at one end of its linear operational direction to the sprung mass of the motor vehicle through the same attachment points as the associated vibration damper or the associated shock absorber and connected at the other end to the unsprung mass of the motor vehicle, and each linear actuator is operated by a controller as a function of values detected with the vehicle in motion, and additional forces are added to or subtracted from the forces acting on the respective vibration damper or shock absorber.

Accordingly, the object of the invention can furthermore also be achieved by a shock absorber of the above-mentioned generic kind in which a linear actuator is provided parallel to the above-referenced assembly of vibration damper and spring, which motor extends between the same pivots. While the linear actuator does not necessarily have to be provided directly at the referenced pivots, it nevertheless introduces its generated forces into the sprung and unsprung mass through these pivots.

What is considered the specific fundamental advantage of the invention is that forces can both be added to and subtracted from the effective forces in a shock absorber by a linear actuator, for example, based on the situation, that is as a function of the detected values. The ability is thus provided of modifying characteristics both for the stabilizer of an axle, the spring of a shock absorber, and also the vibration damper of a shock absorber, not only within a predetermined characteristic family but in virtually any way desired, specifically at least limited only by the magnitude of those forces that can be applied by the linear actuator.

A further advantage of the invention here is that a shock absorber of the type basically known in the prior art needs only to be augmented by an additional linear actuator for which the axial operational direction is parallel to the respective axial operational direction of spring and vibration damper of the shock absorber in order to provide the advantages according to the invention. By locating a linear actuator in a shock absorber that is known per se, the invention thus has the advantage of creating only a small increases in mass that are essentially negligible relative to the driving dynamics of a motor vehicle.

A linear actuator is constructed here in such a way that the motor includes two parts that can move relative to each other, their direction of motion being a straight line with the result that an especially advantageous aspect of the invention is that in implementing the construction of a shock absorber according to the invention the heavier of the two motor parts is connected to the sprung mass of the motor vehicle. In this case the increase in mass created by the second part of an electric motor is especially low relative to the unsprung mass of a motor vehicle, in other words, for example, relative to wheel and its wheel suspension.

In creating a linear actuator in the form of an electric linear actuator comprising a stator and a rotor moving linearly relative thereto, provision can thus be made in a preferred embodiment that the stator of each linear actuator of the sprung mass of the motor vehicle and the rotor of the linear actuator are associated with the unsprung mass of the motor vehicle. To this end, for example, the stator of the linear actuator can be connected to the piston rod of the vibration damper. This construction is thus preferably selected if the stator part is the heavier part of the linear actuator.

In addition to the above-referenced embodiment of the linear actuator in the form of an electric linear actuator, provision can also be made that a hydraulic linear actuator is used which thus utilizes appropriate hydraulic lines to supply various pressures to corresponding hydraulic chambers inside the linear actuator instead of a wiring system to supply electrical control signals. A linear actuator of this type can be, for example in the form of a hydraulically controllable cylinder-piston unit.

Regardless of the mode of action of the linear actuator, a controller can thus be provided that enables each employed linear actuator to be individually controlled as a function of values detected with the vehicle in motion, such as, for example, displacement information (in particular, as a function of time) for the vibration damper displacement between damper cylinder and damper piston rod, and/or acceleration values for piston rod and cylinder of the damper, where the two last-referenced types of detected values can be computed, for example, by single or double time differentiation of the first referenced displacement. For each of the possible control approaches that can be implemented for control, the only requirement, for example, is thus recording detected values by a displacement sensor. Sensors can also of course be used that enable speed and acceleration to be recorded directly without any computational detours.

In one possible embodiment, for example, provision can be made that the application of electrical current to each employed linear actuator in the embodiment using an electric motor as the actuator, or alternatively the application of pressure to the linear actuator in the case of a hydraulic mode of action, are effected as a function of at least one stored, in particular, modifiable characteristic in which displacement values, speed values, or acceleration values are plotted for vibration damper or spring relative to the electrical current, or alternatively the applied pressure or fluid volumetric flow.

In terms of construction, a shock absorber according to the invention can be provided where the linear actuator is provided coaxially, in particular, relative to the assembly of vibration damper and spring. The actual spring and vibration damper here are preferably arranged in a coaxial, or at least aligned configuration. For example, provision can be made according to the invention that the linear actuator surrounds the vibration damper and is inside a spring of the shock absorber that is, for example, in the form of a coil spring.

The last-referenced embodiment can be also be employed, in particular, whenever coilover suspensions are used in which the maximum length of a spring of the shock absorber in the relaxed state is provided by adjusting at least one of the contact sides of the spring, in particular, coil springs by a screw thread.

An especially preferred embodiment of the shock absorber according to the invention in terms of construction is provided if the rotor of the linear actuator is in the form of a hollow sleeve that is provided coaxially in the stator and coaxially surrounding the vibration damper. In the embodiment of the linear actuator as an electric motor, provision can be made here that the sleeve includes a plurality of permanent magnets that are distributed in annular fashion around the circumference of the sleeve, thereby creating multiple rings that are spaced axially relative to each other, in particular, rings in which the permanent magnets are provided in an oblique annular fashion, thus where not all of the permanent magnets lie in one and the same cross-sectional plane.

In order to stabilize a shock absorber according to the invention, provision can be furthermore be made that the stator is mounted in a plain bearing, in particular, a plain bearing bushing.

What is considered to be a special advantage, for example, of this shock absorber or the described method according to the invention is the fact that a previously available production vehicle, or its suspension, can readily and easily be retrofitted in order to test out a modified suspension tuning, essentially that a linear actuator particularly of the above-described type according to the invention, is integrated into the shock absorber.

Provision can optionally be made here that a previously used pneumatic spring suspension of the shock absorber can be replaced by a spring suspension using a coil spring that has the same spring properties.

With only a minimal increase in mass, the previously existing production suspension can thus be retrofitted with linear actuators in the individual shock absorbers, at least in those shock absorbers of the same axle, in order then to test out an individual new tuning of the suspension using an approach, for example, whereby the characteristic of the springs and/or the vibration damper can be modified as desired as a function of values detected with the vehicle moving until a desired tuning is achieved. Modification of the force characteristics of spring and/or vibration damper is effected here by superposition of the existing force characteristic with the force characteristic for the application of electrical current or application of hydraulic force in the linear actuator as a function of detected values.

This then provides the ability, for example, to use the found tuning, that is, in particular, of the characteristics changed by superposition for spring and/or vibration damper to produce corresponding springs and/or vibration dampers that represent the desired response of the characteristic obtained by superposition without using an additional linear actuator.

As a result, any use of additional linear actuators can be dispensed with in a production suspension then to be produced while retaining the same found characteristics or at least similar characteristics. The invention is thus especially appropriate for use at the pre-development stage, as well as in the definition phase, proof-of-concept phase, and production development phase of the suspension development process in advance of the actual preproduction manufacturing stage, although provision can also be made according to the invention that the above-described shock absorbers or entire suspensions are used in production vehicles and enable individual suspension tunings.

What is considered to be an especially advantageous aspect here is that the capability exists of storing in saved fashion at least one characteristic in a central controller for each shock absorber or linear actuator provided therein, or at least for the shock absorbers of linear actuators of the same suspension axle, which characteristic can be readily modified at any time, thereby also providing the ability to reprogram test vehicles in a timely manner or also production vehicles, for example, at normal maintenance intervals using modified characteristics.

An illustrated embodiment of the invention will be described in detail based on the following figures. In the drawings:

FIG. 1 is a schematic diagram of a replacement vehicular suspension forming part of a four-wheel system.

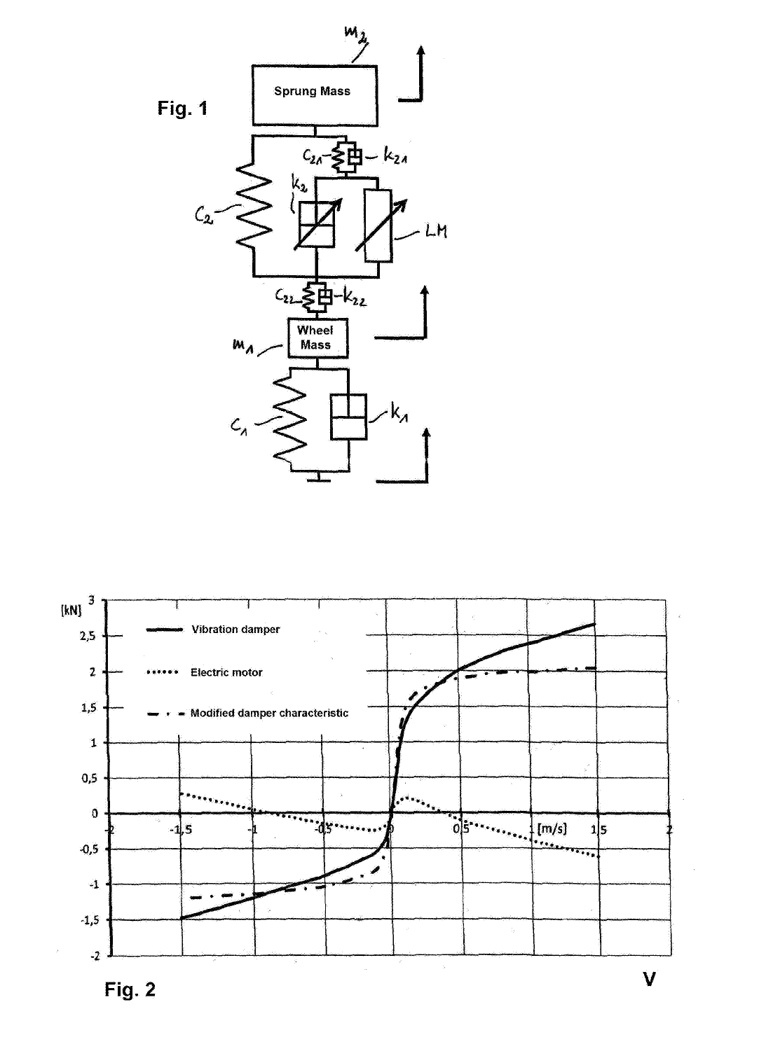

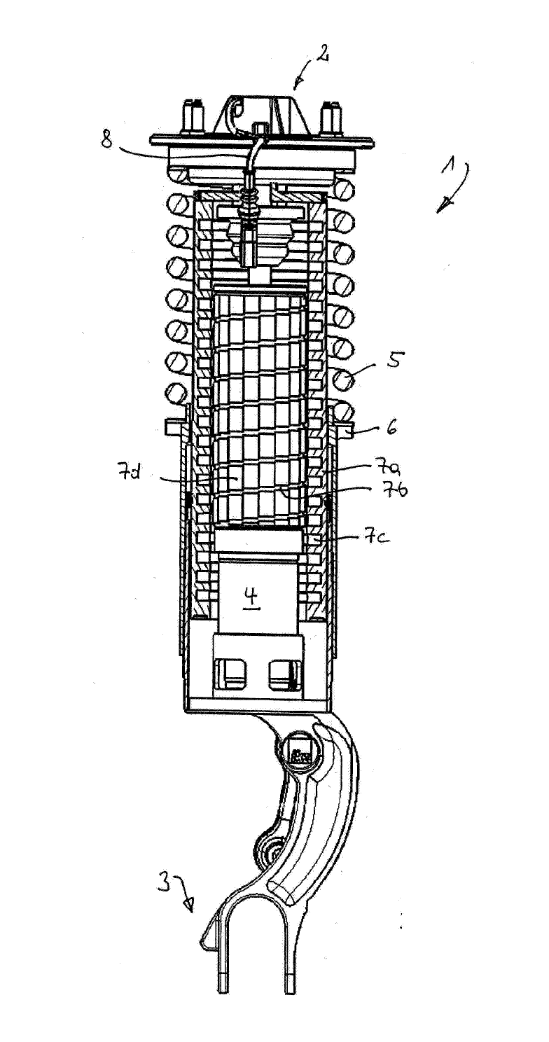

FIG. 2 shows characteristics for a vibration damper, a linear actuator, and their superposition.

FIG. 3 shows the construction of a specific embodiment of a shock absorber with an electric linear actuator.

FIG. 1 is a schematic overall view of the suspension of a motor vehicle, for example, an automobile. The mass of the wheel and of the wheel suspension is indicated by m₁, which is essentially the entire unsprung mass of the motor vehicle that is supported on a roadway by the damping and spring properties of an air-inflated tire.

The characteristics of the tire in terms of damping are represented by the damper symbol k₁ and in terms of spring suspension by the spring symbol c₁.

The same applies for the total sprung mass m₂ of a motor vehicle that is connected to the unsprung mass m₁ of the motor vehicle through a shock absorber created by constructively and functionally parallel-connected parts including a spring and a vibration damper, where here the spring is represented by a spring symbol c₂ and the vibration damper by a damper symbol k₂, and where provision can furthermore be made that the vibration damper k₂ is an adjustable or controllable vibration damper.

The spring symbols and vibration damper symbols k₂₁, c₂₁ and k₂₂, c₂₂ represent the fact that a shock absorber in the usual approach does not connect the two masses m₁ and m₂ either unsprung or undamped, that is, does not connect them rigidly but instead, for example, through elastomer damper and spring elements in or on the pivots that can also effect emergency functions.

The invention is essentially represented by the fact that both functionally and in terms of construction a linear actuator LM is provided relative to spring c₂ and vibration damper k₂ of the shock absorber and motor provides the ability with the vehicle in motion by axial length adjustment to add to or subtract from the forces operating within the shock absorber additional forces to the forces in the shock absorber, in particular, in the spring or the vibration damper, for example, as a function of detected values that are acquired with the vehicle in motion, in particular, from the relevant shock absorber itself, and here in an especially preferred embodiment on the vibration damper of the shock absorber, for which purpose a sensor can be provided, for example, in the form of a displacement sensor in order to detect and record the travel of the piston rod of the vibration damper relative to the cylinder. Alternatively, it is also possible to measure displacement changes between other elements of the shock absorber that are respectively with the pivots.

The ability is accordingly provided to control a linear actuator as a function of the measured displacement, and/or as a function of the speed, for example, after effecting a simple time differentiation of the displacement, and/or as a function of the acceleration at the vibration damper, for example, after effecting a double time differentiation of the displacement.

Depending on the type of linear actuator, an application of electrical current or fluid pressure can be effected as a function of these detected values, for example, when the linear actuator is an electric linear actuator or hydraulic linear actuator. As defined by the invention, detected values are generally also understood to refer to those values that have been generated by computation based on an original measurement value, that is, for example by single or double time differentiation.

FIG. 2 illustrates by way of example one possible way of manipulating the damper characteristic. The unmodified force characteristic for the vibration damper, that is, here the force (in kilonewtons) versus speed (in meters/second) is illustrated first as a solid line as a function of the speed v of the piston rod of the vibration damper relative to the cylinder of the vibration damper.

A force characteristic for the linear actuator is shown as a dotted line in this diagram, the motor being provided in one possible embodiment as an electric motor. This dotted-line characteristic thus represents the force (in kilonewtons) that can be generated by the linear actuator versus speed. The force shown is generated by an application of electrical current, not shown, to the linear actuator as a function of speed.

As indicated by the dotted line, an application of electrical current to the linear actuator formed as an electric linear actuator can thus be effected as a function of a speed measured at the vibration damper or at the shock absorber, in particular, the speed of the piston rod of the vibration damper relative to the cylinder of the vibration damper, in order to generate the force shown in the characteristic, thereby generating a modification of the characteristic for the vibration damper indicated by the dash-dotted line by superposition on the characteristic of the vibration damper.

It is evident here that a modification of the characteristic can be effected so that this modification is possible in all four quadrants, that is, to the right and left as well as above and below the original unmodified characteristic curve. These multi-quadrant changes are not possible with conventional vibration dampers, including controlled or otherwise adjustable vibration dampers, and this aspect therefore highlights the special advantages of the invention.

In the same way as illustrated here for a modification of the damper characteristic, a modification of the spring characteristic can also be effected, this time as a function of the spring travel as the measurement value instead of the speed.

FIG. 3 shows the construction of an especially preferred embodiment of a shock absorber on a suspension of a motor vehicle, for example, an automobile.

The shock absorber 1 includes a top pivot 2 by which the shock absorber can be attached—for example, through an elastomeric bumper—to the chassis and thus to the sprung mass of the motor vehicle, in particular, using an articulated joint, especially preferably, a cardan-type joint.

The shock absorber furthermore includes a bottom pivot 3 that is intended to be connected to the unsprung mass of a motor vehicle, and thus to the wheel and to the elastomer support.

Also following a known approach, this shock absorber includes a vibration damper 4 that can be in the form of a hydraulic or even pneumatic cylinder-piston unit and is provided in such a way, for example, that the unit's cylinder end is connected to the pivot 2 and its piston rod is connected to the pivot 3. Again following the approach known per se for this embodiment, a coil spring 5 is provided coaxially around the vibration damper 4, and a bottom support element 6 of the coil spring 5 can be vertically adjustable by a screw thread, which approach is well-known in a so-called coilover suspension.

The special embodiment according to the invention is provided here by the fact that a linear actuator 7 surrounds the vibration damper 4, the linear actuator comprising a stator 7a and a rotor 7b. The linear actuator here also continues to be oriented coaxially inside the coil spring 5, and is similarly supported at both ends at the pivots 2 and 3, as is also the case for the spring or the vibration damper.

The operational directions of spring, vibration damper, and linear actuator thus are parallel, and the respective central axes of motion in this example coincide, that is, these respective parts are coaxial.

Provision is made in the embodiment depicted here that the stator 7a of the linear actuator, which includes a plurality of grooves 7c, is connected to the pivot 2, with the result that the weight of the stator is added to the sprung mass of the motor vehicle.

The rotor 7b of the linear actuator, which is in the form of a sleeve that surrounds the vibration damper 4, is, on the other hand, preferably connected to the piston rod of the vibration damper 4 and is thus supported on the pivot 3, that is, on the unsprung mass of the motor vehicle.

The diagram of FIG. 3 furthermore also shows here that a plurality of permanent magnets 7d is provided around the sleeve of the rotor 7b, and one group each consisting of a defined number of permanent magnets forms a ring that is oriented at an acute angle, that is, on average not perpendicular to the linear direction of extent of the linear actuator. This thus results in multiple obliquely oriented annular configurations of permanent magnets 7d.

A cable 8 can be provided so that varying levels of electrical current are applied as a function of measured values by a controller to the linear actuator 7, which is operated, for example, using the three-phase principle, and thus forces applied by the linear actuator are subtracted from or added to the forces operating within the shock absorber.

The characteristic of the vibration damper or also the characteristic of the spring can thus be readily modified, as shown in FIG. 2, whereby a characteristic for the force from or the application of electrical current to the linear actuator is easily stored in a controller provided for this purpose, which characteristic is a function of the desired parameter, for example, displacement, speed, or acceleration, and provision can be made that a separate characteristic is stored in a controller for each shock absorber, or optionally identical characteristics can be stored in a controller for the shock absorbers of a shared vehicle axle or also for all shock absorbers. A characteristic for the application of electrical current to a linear actuator is also understood to mean that optionally multiple/different application levels of electrical current are provided, optionally for multiple phases, here, for example three phases.

By using at least one measuring sensor in this shock absorber according to the invention, for example, a displacement sensor that measures the displacement between piston rod and cylinder of the vibration damper, in particular, as a function of time, this controller can be supplied with the required detected values in order based thereon to supply electrical current to the electric motor and thus generate a desired situation-dependent force.

As FIG. 3 further illustrates, the ability exists according to the invention to easily modify existing production-run suspensions in order to create a suspension or shock absorber according to the invention, to which end the linear actuator is simply provided around the vibration damper inside the spring, here a coil spring, which motor is provided in hollow form so as to allow it to surround the damper.

If the intent is to provide an air suspension in a production suspension or shock absorber, provision can be made according to the invention that this air spring is replaced by a coil spring of analogous function, that is, with the same spring rate, in order to thereby create an arrangement of a sleeve-shaped linear actuator surrounding the vibration damper.

In one embodiment in which the illustrated coaxial integration of the linear actuator in the shock absorber is impossible, provision can also be made that the linear actuator is created as an element that is provided axially parallel to and offset relative to the vibration damper and spring in terms of construction. Although this requires an increase in installation space, it nevertheless yields the same advantages according to the invention as in the design diagram of FIG. 3.

1. A method of tuning the suspension of a motor vehicle including a shock absorber and a vibration damper, the method comprising the steps of:
providing a linear actuator in the shock absorber of the vibration damper parallel to the vibration damper;
connecting the linear actuator to the sprung mass of the motor vehicle through the same attachment points as the vibration damper at one end of its linear operational direction and to the unsprung mass of the motor vehicle at the other end; and
operating each linear actuator by a controller as a function of values detected with the vehicle in motion by adding or subtracting additional forces from the forces acting on the vibration damper.

2. The method according to claim 1, further comprising the step of:
installing the linear actuator in the production suspension of the associated previous production motor vehicle when a new motor vehicle is being developed.

3. The method according to further comprising the step, when the linear actuator is a linear electric motor, of:
connecting the stator of the linear actuator with the sprung mass of the motor vehicle and the rotor of the linear actuator with the unsprung mass of the motor vehicle.

4. The method according to claim 3, further comprising the step of:
applying electrical current to the linear actuator as a function of at least one stored modifiable characteristic in which the displacement and/or the speed and/or the acceleration of the vibration damper is plotted versus the electrical current.

5. A shock absorber for a suspension of a motor vehicle having a sprung mass and an unsprung mass, comprising:
a top pivot connecting the shock absorber to the sprung mass of the motor vehicle and a bottom pivot connecting the shock absorber to the unsprung mass of the motor vehicle,
an assembly of a vibration damper and a spring provided between the pivots;
a linear actuator extending parallel to the assembly and between the pivots.

6. The shock absorber according to claim 5, wherein the linear actuator is provided coaxially relative to the assembly of vibration damper and spring around the vibration damper, and inside a coil spring.

7. The shock absorber according to claim 5, wherein the linear actuator is an electric motor, and the stator of the linear actuator is connected to the piston rod of the vibration damper.

8. The shock absorber according to claim 6, wherein the rotor is provided in the form of a sleeve that is provided coaxially in the stator and coaxially around the vibration damper, the sleeve including a plurality of permanent magnets that are distributed in annular fashion in multiple axially spaced rings in oblique annular fashion around the circumference of the sleeve.

9. The shock absorber according to claim 7, wherein the stator is mounted in a plain bearing bushing.
